(19) United States
(12) Patent Application Publication
(10) Pub. No.: US 2023/0098981 A1
(43) Pub. Date: Mar. 30, 2023

(54) Common Supplier Visualization

(71) Applicant: S&P Global Inc., New York, NY (US)

(72) Inventors: Jonathan Edward Hoyt Hayden, Westford, MA (US); Robert George Christie, Somerville, MA (US); Michael Albert Vezza, Weston, MA (US); James Ryan Psota, Cambridge, MA (US)

(21) Appl. No.: 17/449,348

(22) Filed: Sep. 29, 2021

(51) Int. Cl. G06Q 10/08; G06Q 30/06; G06F 9/451

(52) U.S. Cl. CPC G06Q 10/0835; G06Q 30/0633; G06F 9/451

(57) ABSTRACT

A computer-implemented method for visualizing a supply chain is provided. The method comprises receiving a selection of a first company stored in a database and retrieving, from the database, a first number of consignment companies that buy products from the first company. A second number of consignment companies that buy products from the first number of consignment companies are retrieved from the database. The method further comprises retrieving, from the database, a first number of supplier companies that sell products to the first company and then retrieving, from the database, a second number of supplier companies that sell products to the first number of supplier companies. A supply chain tree diagram is displayed in an interface, wherein the consignment companies and supplier companies are displayed as nodes branching from the first company.

### BACKGROUND INFORMATION

### 1. Field

The present disclosure relates generally to an improved computing system, and more specifically to a method of visualizing a supply chain comprising suppliers and consignees of a selected company.

### 2. Background

Trading relationships between participants in a supply chain are not easily discernable. For a given company within the supply chain the company's immediate suppliers and buyers are readily discoverable. However, the other companies further back and down the supply chain may not be apparent. Within a particular industry, different companies might share common suppliers and buyers at respective distant points in the supply chain.

Therefore, it would be desirable to have a method and apparatus that take into account at least some of the issues discussed above, as well as other possible issues.

### SUMMARY

An illustrative embodiment provides computer-implemented method for visualizing a supply chain. The method comprises receiving a selection of a first company stored in a database and retrieving, from the database, a first number of consignment companies that buy products from the first company. A second number of consignment companies that buy products from the first number of consignment companies are retrieved from the database. The method further comprises retrieving, from the database, a first number of supplier companies that sell products to the first company and then retrieving, from the database, a second number of supplier companies that sell products to the first number of supplier companies. A supply chain tree diagram is displayed in an interface, wherein the consignment companies and supplier companies are displayed as nodes branching from the first company.

Another illustrative embodiment provides a system for visualizing a supply chain. The system comprises a storage device configured to store program instructions, and one or more processors operably connected to the storage device and configured to execute the program instructions to cause the system to: receive a selection of a first company stored in a database; retrieve, from the database, a first number of consignment companies that buy products from the first company; retrieve, from the database, a second number of consignment companies that buy products from the first number of consignment companies; retrieve, from the database, a first number of supplier companies that sell products to the first company; retrieve, from the database, a second number of supplier companies that sell products to the first number of supplier companies; and display, in an interface, a supply chain tree diagram, wherein the consignment companies and supplier companies are displayed as nodes branching from the first company.

Another illustrative embodiment provides a computer program product for visualizing a supply chain. The computer program product comprises a computer-readable storage medium having program instructions embodied thereon to perform the steps of: receiving a selection of a first company stored in a database; retrieving, from the database, a first number of consignment companies that buy products from the first company; retrieving, from the database, a second number of consignment companies that buy products from the first number of consignment companies; retrieving, from the database, a first number of supplier companies that sell products to the first company; retrieving, from the database, a second number of supplier companies that sell products to the first number of supplier companies; and displaying, in an interface, a supply chain tree diagram, wherein the consignment companies and supplier companies are displayed as nodes branching from the first company.

Another illustrative embodiment provides a computer-implemented method for visualizing a supply chain. The method comprises receiving a selection of a profile company stored in a database and retrieving, from the database, a number of consignment companies that buy products directly from the profile company. A second number of consignment companies that buy products from the first number of consignment companies are then retrieved from the database. The method also comprises retrieving, from the database, a first number of supplier companies that sell products directly to the profile company. A second number of supplier companies that sell products to the first number of supplier companies are retrieved from the database. A bi-directional supply chain tree diagram centered on the profile company is displayed in an interface, wherein the first number of consignment companies branch off to a first side of the profile company, and the second number of consignment companies branch off the first number of consignment companies, and wherein the first number of supplier companies branch off to a second side of the profile company, and the second number of supplier companies branch off the first number of supplier companies.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a supply chain visualization system depicted in accordance with an illustrative embodiment;

FIG. 3 illustrates a bi-directional supply chain diagram in accordance with an illustrative embodiment;

FIG. 4 illustrates a buyer only supply chain diagram in accordance with an illustrative embodiment;

FIG. 5 illustrates a supplier only supply chain diagram in accordance with an illustrative embodiment;

FIG. 6 depicts a flowchart illustrating a process for visualizing a supply chain in a corporate hierarchy in accordance with an illustrative embodiment; and

FIG. 7 is a block diagram of a data processing system in accordance with an illustrative embodiment.

### DETAILED DESCRIPTION

The illustrative embodiments recognize and take into account one or more different considerations. The illustrative embodiments recognize and take into account that trading relationships between participants in a supply chain are not easily discernable. For a given company within the supply chain the company's immediate suppliers and buyers are readily discoverable.

The illustrative embodiments also recognize and take into account that other companies further back and down the supply chain may not be apparent.

The illustrative embodiments provide a method for visualizing participants in a supply chain. Suppliers of a company are identified, and then suppliers of the suppliers can be identified. Similarly, buyers from the company are identified, and buyers from those buyers

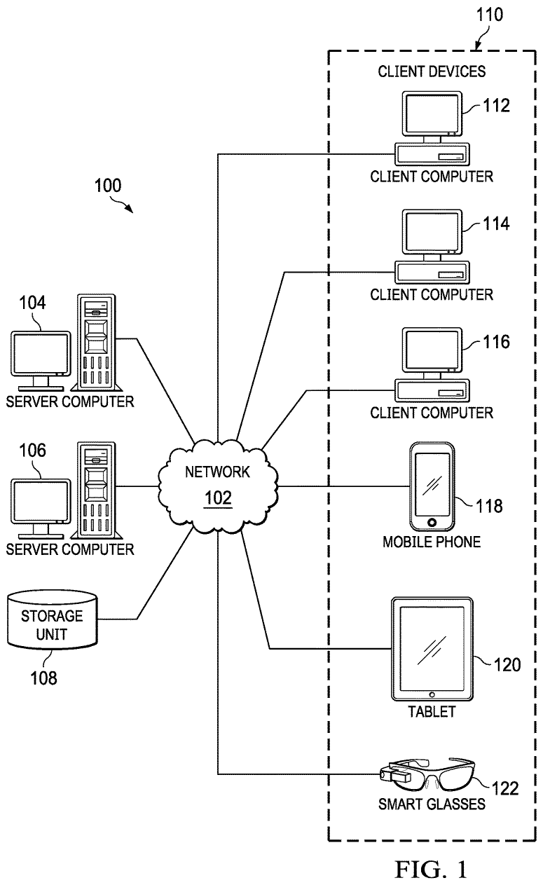

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

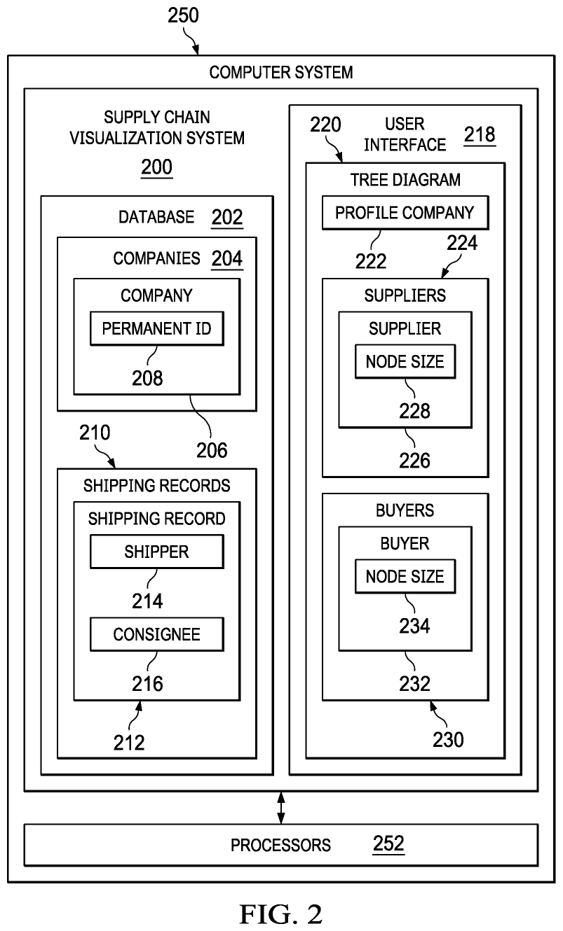

FIG. 2 is a block diagram of a supply chain visualization system depicted in accordance with an illustrative embodiment. Supply chain visualization system 200 might be implemented in network data processing system 100 in FIG. 1.

Supply chain visualization system 200 comprises a database 202 of companies 204. Each company 206 has a unique permanent ID 208 associated with it. Database 202 contains a number of shipping records 210 of trading between the companies 204. Each shipping record 212 lists a shipper/supplier 214 and a corresponding consignee/buyer 216. A given company might be listed as a shipper in one shipping record and a consignee in another record depending on the company's role in a given shipping transaction.

Supply chain visualization system 200 comprises a user interface 218 that can display a supply chain tree diagram 220 in response to a user search. In response to a user selection of a profile company 222 from database 202, supply chain visualization system 200 identifies companies that sell to and buy from profile company 222. These suppliers and buyers can be identified by their permanent IDs 208 in shipping records 210 in which they appear with profile company 222.

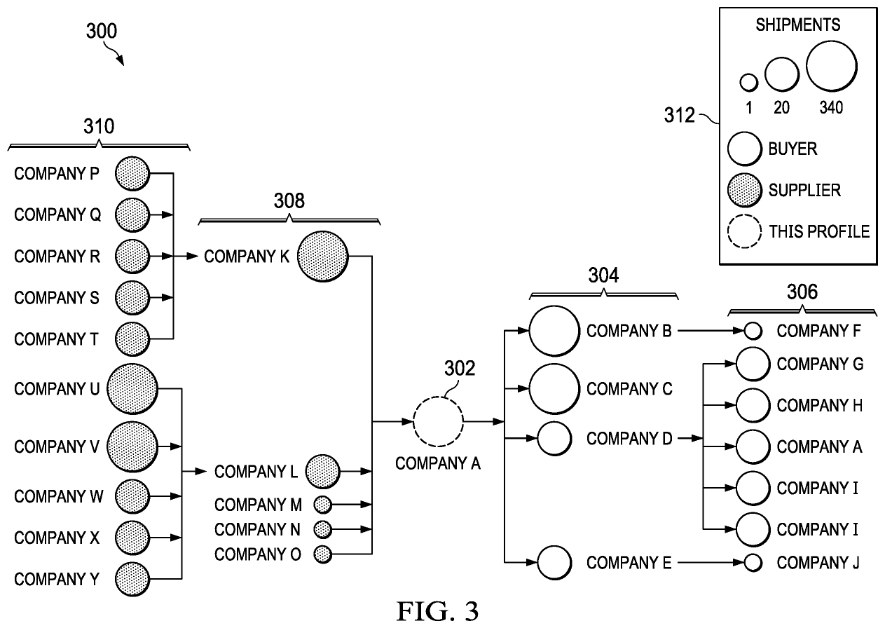

Suppliers 224 can be display in tree diagram 220 with profile company 222. Furthermore, companies that sell to the suppliers of profile company 222 can also be identified from shipping records 210 and included among suppliers 224 in tree diagram 220. Each supplier 226 is displayed as a node in tree diagram 220 with an associated node size 228. Node size might be determined according to the number of shipments made by the supplier 226 to either profile company 222 or a supplier of profile company 222. (See FIG. 3). Node size 228 as measured by the number of shipping records denotes the relative strength of the trading relationship between two companies.

Similarly, buyers 230 can be display in tree diagram 220 with profile company 222. Companies that in turn buy from the consignees of profile company 222 can also be identified from shipping records 210 and included among buyers 230 in tree diagram 220. Similar to the suppliers 224, each buyer 232 is displayed as a node in tree diagram 220 with an associated node size 234 determined by the number of shipments received by the buyer 232 from either profile company 222 or a consignee of profile company 222. As with node size 228, node size 234 denotes the relative strength of the trading relationship between two companies.

Supply chain visualization system 200 can be implemented in software, hardware, firmware, or a combination thereof. When software is used, the operations performed by supply chain visualization system 200 can be implemented in program code configured to run on hardware, such as a processor unit. When firmware is used, the operations performed by supply chain visualization system 200 can be implemented in program code and data and stored in persistent memory to run on a processor unit. When hardware is employed, the hardware may include circuits that operate to perform the operations in supply chain visualization system 200.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

These components for supply chain visualization system 200 can be located in computer system 250, which is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

For example, supply chain visualization system 200 can run on one or more processors 252 in computer system 250. As used herein a processor unit is a hardware device and is comprised of hardware circuits such as those on an integrated circuit that respond and process instructions and program code that operate a computer. When one or more processors 252 execute instructions for a process, one or more processors 252 that can be on the same computer or on different computers in computer system 250. In other words, the process can be distributed between processors 252 on the same or different computers in computer system 250. Further, one or more processors 252 can be of the same type or different type of processors 252. For example, one or more processors 252 can be selected from at least one of a single core processor, a dual-core processor, a multi-processor core, a general-purpose central processing unit (CPU), a graphics processing unit (GPU), a digital signal processor (DSP), or some other type of processor.

FIG. 3 illustrates a bi-directional supply chain diagram in accordance with an illustrative embodiment. Tree diagram 300 might be an example of tree diagram 220 in FIG. 2.

Tree diagram 300 displays multi-level trading relationships of a supply chain to which a selected profile company 302 belongs. In addition to showing suppliers and buyers for profile company 302, tree diagram also displays suppliers of the suppliers and buyers of the buyers. The tree diagram 300 comprises a bi-directional diagram in which a first number of consignment companies 304 (buyers from profile company 302) and a second numbers of consignment companies 306 (buyers from company 304) are displayed as nodes on one side of the first (profile) company 302. Conversely, a first number of supplier companies 308 (shippers to profile company 302) and a second number of supplier companies 310 (shippers to suppliers 308) are displayed as nodes on the opposite side of the first profile company 302 from the consignment companies 304, 306.

As shown by key 312, the size of the nodes in tree diagram 300 can be based on the number of shipments sent or received by a given company, denoting the strength of trading relationships between any two companies in the supply chain.

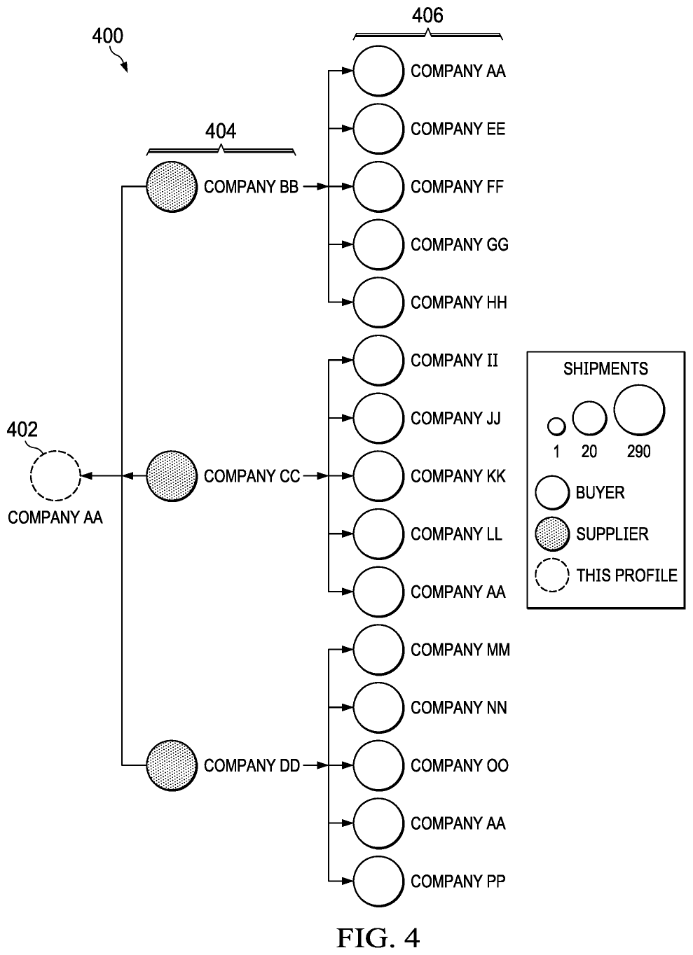

FIG. 4 illustrates a buyer only supply chain diagram in accordance with an illustrative embodiment. Buyer only diagram 400 might be another example of tree diagram 220 in FIG. 2. Buyer only diagram 400 illustrates buyers that share direct suppliers in common with profile company 402.

The buyer only tree diagram 400 displays a subset of a first number of supplier companies 404 as nodes branching from the first (profile) company 402. A number of respective consignment companies 406 that also buy products from the first number of supplier companies 404 is displayed as respective nodes branching from the subset of the first number of supplier companies 404. As in tree diagram 300, the size of the nodes may be based on the number of shipments.

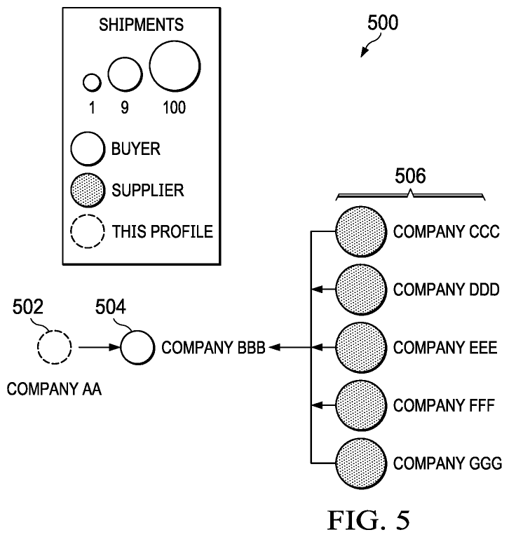

FIG. 5 illustrates a supplier only supply chain diagram in accordance with an illustrative embodiment. Supplier only diagram 500 might be another example of tree diagram 220 in FIG. 2. Supplier only diagram 500 illustrates suppliers that share a direct buyer in common with profile company 502.

The supplier only tree diagram 500 may display a subset 504 of a first number of consignment companies as nodes branching from the first (profile) company 502. In the present example, the subset 504 comprises a single consignment company. A number of respective supplier companies 506 that sell products to the subset 504 of the first number of consignment companies is displayed as respective nodes branching from the subset 504 of the first number of consignment companies. Again, the size of the nodes may be based on the number of shipments for the company in question.

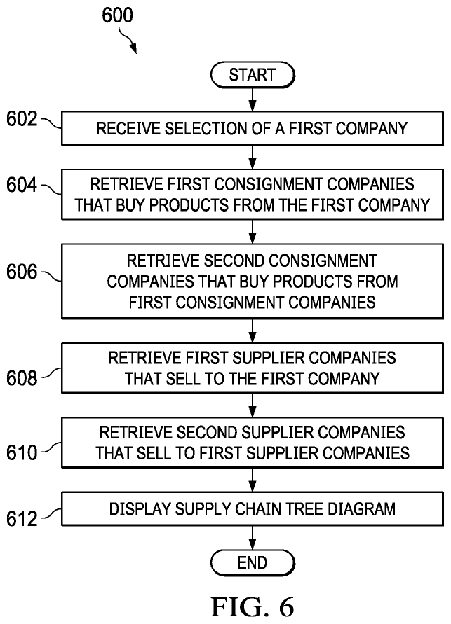

FIG. 6 depicts a flowchart illustrating a process for visualizing a supply chain in a corporate hierarchy in accordance with an illustrative embodiment. Process 600 can be implemented in hardware, software, or both. When implemented in software, the process can take the form of program code that is run by one of more processor units located in one or more hardware devices in one or more computer systems. Process 600 might be implemented in supply chain visualization system 200 in FIG. 2.

Process 600 begins by receiving a selection of a first company stored in a database (step 602). The first company may be an example of a profile company 222 in FIG. 2.

Process 600 then retrieves from the database a first number of consignment companies that buy products from the first company (step 604). The first number of consignment companies may be identified according to first shipping records in which the first company is listed as a shipper.

Process 600 then retrieves a second number of consignment companies from the database that buy products from the first number of consignment companies (step 606). The second number of consignment companies may be identified according to second shipping records in which the first number of consignment companies are listed as shippers.

Process 600 retrieves from the database a first number of supplier companies that sell products to the first company (step 608). The first number of supplier companies is identified according to third shipping records in which the first company is listed as a buyer.

Process 600 then retrieves a second number of supplier companies form the database that sell products to the first number of supplier companies (step 610). The second number of supplier companies is identified according to fourth shipping records in which the first number of supplier companies are listed as buyers.

Process 600 displays a supply chain tree diagram in an interface, wherein the consignment companies and supplier companies are displayed as nodes branching from the first company (step 612). The nodes may be sized according to a number of shipping records associated with each node in the database.

Process 600 then ends.

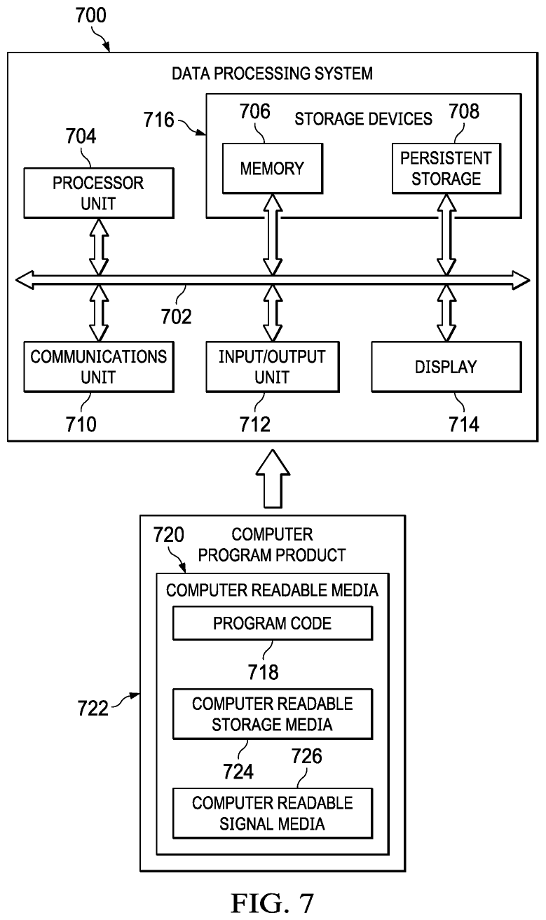

Turning now to FIG. 7, an illustration of a block diagram of a data processing system is depicted in accordance with an illustrative embodiment. Data processing system 700 may be used to implement server computers 104 and 106 and client devices 110 in FIG. 1, as well as computer system 250 in FIG. 2. In this illustrative example, data processing system 700 includes communications framework 702, which provides communications between processor unit 704, memory 706, persistent storage 708, communications unit 710, input/output unit 712, and display 714. In this example, communications framework 702 may take the form of a bus system.

Processor unit 704 serves to execute instructions for software that may be loaded into memory 706. Processor unit 704 may be a number of processors, a multi-processor core, or some other type of processor, depending on the particular implementation. In an embodiment, processor unit 704 comprises one or more conventional general-purpose central processing units (CPUs). In an alternate embodiment, processor unit 704 comprises one or more graphical processing units (CPUs).

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708. Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Computer readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 718 may be transferred to data processing system 700 using computer-readable signal media 726. Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code 718.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for visualizing a supply chain, the method comprising:
using a number of processors to perform the steps of:
receiving a selection of a first company stored in a database;
retrieving, from the database, a first number of consignment companies that buy products from the first company;
retrieving, from the database, a second number of consignment companies that buy products from the first number of consignment companies;
retrieving, from the database, a first number of supplier companies that sell products to the first company;
retrieving, from the database, a second number of supplier companies that sell products to the first number of supplier companies; and
displaying, in an interface, a supply chain tree diagram, wherein the consignment companies and supplier companies are displayed as nodes branching from the first company.

2. The method of claim 1, wherein:
the first number of consignment companies is identified according to first shipping records in which the first company is listed as a shipper; and
the second number of consignment companies is identified according to second shipping records in which the first number of consignment companies are listed as shippers.

3. The method of claim 1, wherein:
the first number of supplier companies is identified according to third shipping records in which the first company is listed as a buyer; and
the second number of supplier companies is identified according to fourth shipping records in which the first number of supplier companies are listed as buyers.

4. The method of claim 1, wherein nodes are sized according to a number of shipping records associated with each node in the database.

5. The method of claim 1, wherein the tree diagram comprises a bi-directional diagram in which the first number of consignment companies and second numbers of consignment companies are displayed as nodes on one side of the first company, and the first number of supplier companies and second number of supplier companies are displayed as nodes on the opposite side of the first company.

6. The method of claim 1, further comprising displaying a buyer only tree diagram wherein a subset of the first number of supplier companies is displayed as nodes branching from the first company and a third number of respective consignment companies that buy products from the subset of the first number of supplier companies is displayed as respective nodes branching from the subset of the first number of supplier companies.

7. The method of claim 1, further comprising displaying a supplier only tree diagram wherein a subset of the first number of consignment companies is displayed as nodes branching from the first company and a third number of respective supplier companies that sell products to the subset of the first number of consignment companies is displayed as respective nodes branching from the subset of the first number of consignment companies.

8. A system for visualizing a supply chain, the system comprising:
a storage device configured to store program instructions; and
one or more processors operably connected to the storage device and configured to execute the program instructions to cause the system to:
receive a selection of a first company stored in a database;
retrieve, from the database, a first number of consignment companies that buy products from the first company;
retrieve, from the database, a second number of consignment companies that buy products from the first number of consignment companies;
retrieve, from the database, a first number of supplier companies that sell products to the first company;
retrieve, from the database, a second number of supplier companies that sell products to the first number of supplier companies; and
display, in an interface, a supply chain tree diagram, wherein the consignment companies and supplier companies are displayed as nodes branching from the first company.

9. The system of claim 8, wherein:
the first number of consignment companies is identified according to first shipping records in which the first company is listed as a shipper; and
the second number of consignment companies is identified according to second shipping records in which the first number of consignment companies are listed as shippers.

10. The system of claim 8, wherein:
the first number of supplier companies is identified according to third shipping records in which the first company is listed as a buyer; and
the second number of supplier companies is identified according to fourth shipping records in which the first number of supplier companies are listed as buyers.

11. The system of claim 8, wherein nodes are sized according to a number of shipping records associated with each node in the database.

12. The system of claim 8, wherein the tree diagram comprises a bi-directional diagram in which the first number of consignment companies and second numbers of consignment companies are displayed as nodes on one side of the first company, and the first number of supplier companies and second number of supplier companies are displayed as nodes on the opposite side of the first company.

13. The system of claim 8, wherein the processors further execute instructions for displaying a buyer only tree diagram wherein a subset of the first number of supplier companies is displayed as nodes branching from the first company and a third number of respective consignment companies that buy products from the subset of the first number of supplier companies is displayed as respective nodes branching from the subset of the first number of supplier companies.

14. The system of claim 8, wherein the processors further execute instructions for displaying a supplier only tree diagram wherein a subset of the first number of consignment companies is displayed as nodes branching from the first company and a third number of respective supplier companies that sell products to the subset of the first number of consignment companies is displayed as respective nodes branching from the subset of the first number of consignment companies.

15. A computer program product for visualizing a supply chain, the computer program product comprising:
a computer-readable storage medium having program instructions embodied thereon to perform the steps of:
receiving a selection of a first company stored in a database;
retrieving, from the database, a first number of consignment companies that buy products from the first company;
retrieving, from the database, a second number of consignment companies that buy products from the first number of consignment companies;
retrieving, from the database, a first number of supplier companies that sell products to the first company;
retrieving, from the database, a second number of supplier companies that sell products to the first number of supplier companies; and
displaying, in an interface, a supply chain tree diagram, wherein the consignment companies and supplier companies are displayed as nodes branching from the first company.

16. The computer program product of claim 15, wherein:
the first number of consignment companies is identified according to first shipping records in which the first company is listed as a shipper; and
the second number of consignment companies is identified according to second shipping records in which the first number of consignment companies are listed as shippers.

17. The computer program product of claim 15, wherein:
the first number of supplier companies is identified according to third shipping records in which the first company is listed as a buyer; and
the second number of supplier companies is identified according to fourth shipping records in which the first number of supplier companies are listed as buyers.

18. The computer program product of claim 15, wherein nodes are sized according to a number of shipping records associated with each node in the database.

19. The computer program product of claim 15, wherein the tree diagram comprises a bi-directional diagram in which the first number of consignment companies and second numbers of consignment companies are displayed as nodes on one side of the first company, and the first number of supplier companies and second number of supplier companies are displayed as nodes on the opposite side of the first company.

20. The computer program product of claim 15, further comprising instructions for displaying a buyer only tree diagram wherein a subset of the first number of supplier companies is displayed as nodes branching from the first company and a third number of respective consignment companies that buy products from the subset of the first number of supplier companies is displayed as respective nodes branching from the subset of the first number of supplier companies.

21. The computer program product of claim 15, further comprising instructions for displaying a supplier only tree diagram wherein a subset of the first number of consignment companies is displayed as nodes branching from the first company and a third number of respective supplier companies that sell products to the subset of the first number of consignment companies is displayed as respective nodes branching from the subset of the first number of consignment companies.

22. A computer-implemented method for visualizing a supply chain, the method comprising:
using a number of processors to perform the steps of:
receiving a selection of a profile company stored in a database;
retrieving, from the database, a first number of consignment companies that buy products directly from the profile company;
retrieving, from the database, a second number of consignment companies that buy products from the first number of consignment companies;
retrieving, from the database, a first number of supplier companies that sell products directly to the profile company;
retrieving, from the database, a second number of supplier companies that sell products to the first number of supplier companies; and
displaying, in an interface, a bi-directional supply chain tree diagram centered on the profile company, wherein the first number of consignment companies branch off to a first side of the profile company, and the second number of consignment companies branch off the first number of consignment companies, and wherein the first number of supplier companies branch off to a second side of the profile company, and the second number of supplier companies branch off the first number of supplier companies.
